(19) United States
(12) Patent Application Publication
(10) Pub. No.: US 2026/0326212 A1
(43) Pub. Date: Oct. 22, 2026

(54) TWIST DRILL

(71) Applicant: Gühring KG, Albstadt (DE)

(72) Inventor: Stefan ROTHENAICHER, Erkheim (DE)

(73) Assignee: Gühring KG, Albstadt (DE)

(21) Appl. No.: 19/574,333

(22) Filed: Mar. 21, 2026

(30) Foreign Application Priority Data
Apr. 16, 2025 (DE) 102025114937.2

(51) Int. Cl. B23B 51/02

(52) U.S. Cl. CPC B23B 51/02; B23B 2251/04; B23B 2251/125; B23B 2251/202; B23B 2251/40

(57) ABSTRACT

A twist drill (1) with a shank (2) and a cutting part (3) is provided, which has at least two webs, which are separated from one another in the circumferential direction of the twist drill (1) by means of main chip grooves (5) and which are in each case divided into a leading web (10) and a trailing web (20), which each have a secondary cutting edge (12, 22), in the circumferential direction of the twist drill (1) by means of a secondary chip groove (6), which runs along the web. For each web, the trailing web (20) ends upstream of the leading web (10) in the direction of the shank (2) and the secondary chip groove (6) ends in a trailing main chip groove (5).

The invention relates to a twist drill for drilling into solid material, as described and claimed herein.

Twist drills of this type are used in a variety of configurations. They extend along a longitudinal central axis and have a shank as well as a cutting part. The cutting part usually has at least two cutting webs or webs, which each form a cutting wedge with a main cutting edge. The main cutting edge of the cutting wedge is thereby formed from cutting line of a chip surface, over which the chip runs into a main chip groove, which runs helically along the twist drill at an angle of twist, and a clearance surface. The main cutting edges are usually arranged at a tip angle of significantly less than 180° to one another in order to ensure a good centering of the twist drill in the workpiece. The main cutting edge runs radially outwards to a cutting edge corner, where it transitions into a secondary cutting edge, which is provided for the post-processing of the bore and which is adjoined in the circumferential direction by a guide chamfer and a clearance surface. The main cutting edges are connected to one another via a cross cutting edge in the region of the drill center. A point thinning can decrease the cross cutting edge in order to better center the twist drill and in particular in order to simplify the spot drilling when drilling into solid material.

It is furthermore known that the webs have a second secondary cutting edge, which trails the (first) secondary cutting edge in the direction of rotation of the twist drill and which, in turn, is adjoined in the circumferential direction by a guide chamfer and a clearance surface. This second secondary cutting edge can lie on the same diameter as the first secondary cutting edge and can ensure a further post-processing of the bore wall. Leading the second secondary cutting edge in the direction of rotation, the webs each have a secondary chip groove, which extends along the web and via which the chips removed by the second secondary cutting edge can be discharged.

A double-edged twist drill with a shank and a cutting part is known from the publication DE 33 25 149A1, which has two webs, which are separated from one another by means of helically running main chip grooves. On a front end in the feed direction of the twist drill, each web forms a main cutting edge. The main cutting edges running at a tip angle are connected by means of a cross cutting edge and are corrected by means of point thinnings, which simultaneously shorten the cross cutting edge and thus ensure a good centering behavior. Each main cutting edge runs radially outwards to a cutting edge corner, where it transitions into a secondary cutting edge, which extends helically along a main chip groove to a shank. In addition to the secondary cutting edge, each web has an additional secondary cutting edge, which trails the secondary cutting edge and which lies on the same diameter as the secondary cutting edge and runs to the shank of the twist drill. With its chip surface, a secondary chip groove, which runs along the web between the secondary cutting edges, defines the additional secondary cutting edge and discharges chips removed by the additional secondary cutting edge in the direction of the shank.

Bores with a high surface quality can be produced in one operating step by means of the twist drill described in the DE 33 25 149A1. In particular the additional secondary cutting edges contribute to this, which further smoothen the bore formed or post-processed, respectively, by the main cutting edges and secondary cutting edges, so that a separate post-processing of the bore can either be dispensed with completely or the time for the post-processing can be reduced significantly.

It is disadvantage of the twist drill of the DE 33 25 149 A1 that due to the additional secondary cutting edges, which extend over the entire length of the cutting part to the shank, continuous chips or spiral chips, which prevent the drilling process or which can jam with the bore wall, can form in the region of the secondary chip grooves formed along the webs, so that the drilling process for removing the chips has to be interrupted and the processing time increases.

Based on the twist drill described in the DE 33 25 149A1, the invention is thus based on the object of providing a twist drill, which is able to produce bores with a high surface quality and which simultaneously avoids the formation of continuous chips or spiral chips.

This object can be solved by means of a twist drill with the features described and claimed herein.

The twist drill has a shank and a cutting part, which has at least two webs, which are separated from one another in the circumferential direction of the twist drill by means of main chip grooves and which are in each case divided into a leading web and a trailing web, which each have a secondary cutting edge, in the circumferential direction of the twist drill by means of a secondary chip groove, which runs along the web. For each web, the trailing web can end upstream of the leading web in the direction of the shank and the secondary chip groove can end in a trailing main chip groove. In a region, which lies axially downstream from the trailing web, i.e., axially downstream from the outlet of the secondary chip groove, the main chip groove thus extends in the circumferential direction of the twist drill to a back of the leading leading web.

On a front end in the feed direction of the twist drill, the webs of the cutting part can each form a main cutting edge, which perform the majority of the machining work of the twist drill. The main cutting edges can be defined by a chip surface of the main chip groove and can be connected to one another via one or several cross cutting edges.

The main chip grooves serve in particular for the chip discharge of the chips, which are removed by the main cutting edges.

In the region of the drill core, the twist drill can have a centering tip, which simplifies the centering of the twist drill in the workpiece. The course of the main cutting edge can furthermore be corrected by means of a point thinning. The cross cutting edge or the cross cutting edges can in particular be shortened by the point thinning, whereby the centering behavior of the twist drill is further improved. A tip angle formed between the main cutting edges can be constant or vary over the length of the main cutting edges.

Each main cutting edge can run radially outwards to a cutting edge corner, where it transitions into a secondary cutting edge formed on the leading web. Depending on the material to be machined, the cutting edge corner can be rounded by one or several ground sections, so that the course of the main cutting edge and/or the course of the secondary cutting edge is corrected in the region of the cutting edge corner. Each secondary cutting edge can be adjoined in the usual manner by a guide chamfer. The secondary cutting edge of the leading web, which can also be referred to as leading secondary cutting edge, the secondary cutting edge of the trailing web, which can also be referred to as trailing secondary cutting edge, and the guide chamfers support the centering of the twist drill in the borehole and additionally post-process the side surfaces of the borehole. Chips removed by the leading secondary cutting edge are discharged in the direction of the shank via the main chip groove leading the leading secondary cutting edge and chips removed by the trailing secondary cutting edge are discharged in the direction of the shank via the secondary chip groove, which divides the web into leading web and trailing web in the circumferential direction of the twist drill. The trailing secondary cutting edge can further increase the guidance of the twist drill and can better distribute the loads acting on the cutting edges. The twist drill is less prone to running off-center, whereby the chip discharge and surface quality can be further improved.

For each web, the trailing web can end upstream of the leading web in the direction of the shank and the secondary chip groove can lead into a trailing main chip groove. By means of this design, it is achieved, compared to a twist drill, in the case of which the trailing web, like the leading web, extends over the entire axial length of the cutting part to the shank, that the secondary cutting edge formed on the trailing web is shorter in the direction of its extension. The formation of relatively long continuous chips or spiral chips, which can impede the drilling process or which can jam with the bore wall, due to the trailing secondary cutting edge can thus be prevented. Chips, which are removed from the bore wall by the trailing secondary cutting edge can be transferred into the trailing main chip groove via the secondary chip group ending in the trailing main chip groove and can finally be transported away securely and reliably in the direction of the shank via the trailing main chip groove.

In a further embodiment, the secondary cutting edges each have a positive back rake angle, preferably a positive back rake angle of at least 15°.

The back rake angle of the secondary cutting edges is referred to as an angle, which, viewed in a radial section or a section of the twist drill viewed perpendicular to the axis of rotation of the twist drill, respectively, is formed between a chip surface defining the secondary cutting edge, i.e., a chip surface of the main chip groove or a chip surface of the secondary chip groove, respectively, and a tool reference plane, which, in this cut, is perpendicular to the machining surface and runs through the axis of rotation. Compared to a back rake angle of 0° or a negative back rake angle, a positive back rake angle ensures a smaller wedge angle of the secondary cutting edge, whereby the centering of the twist drill is improved and the material to be drilled is cut and not scraped.

However, depending on the material to be machined, on the demands on the surface quality to be achieved and on the desired stability of the secondary cutting edges, the back rake angle of the secondary cutting edges can also be 0° or negative.

The length of the trailing secondary cutting edge for each web can be 5% to 10% of the length of the leading secondary cutting edge.

When the length of the trailing secondary cutting edge, which is measured in the respective direction of extension, is 5% to 10% of the length of the leading secondary cutting edge, it is achieved on the one hand that the trailing secondary cutting edge can carry out a sufficient post-processing of the bore wall in order to achieve a high surface quality and that the stability of the twist drill is increased. On the other hand, it can be prevented that long continuous chips or spiral chips, which can obstruct the drilling process or which can jam with the bore wall and lead to an interruption of the drilling process, are produced during the drilling process by means of the trailing secondary cutting edge. The chips removed by the trailing secondary cutting edge can be transferred into the trailing main chip groove via the secondary chip groove, which ends in the trailing main chip groove and can finally be transported away securely and reliably in the direction of the shank via the trailing main chip groove.

In a further embodiment, the leading secondary cutting edge and the trailing secondary cutting edge for each web can run parallel to one another.

The parallelism of the secondary cutting edges of each cutting web improves the guidance of the twist drill in the borehole, whereby an off-center running or wandering of the drill can be reduced.

The leading secondary cutting edge and the trailing secondary cutting edge for each web can lie on the same diameter.

When the leading secondary cutting edge and the trailing secondary cutting edge lie on the same diameter, the cutting forces acting on the secondary cutting edges can be distributed better. As a whole, the twist drill centers itself better and runs more smoothly, which is advantageous in particular when spot drilling without preliminary bore and when drilling relatively hard materials.

In a further embodiment, the leading secondary cutting edge and the trailing secondary cutting edge for each web lie axially at the same height in the feed direction of the twist drill in the direction of the drill tip.

It is achieved by means of this design that the leading secondary cutting edge and the trailing secondary cutting edge start machining the workpiece material at the same time during a drilling process. The cutting force is thus distributed evenly to both secondary cutting edges, whereby the service life of the twist drill can be increased. As a whole, the centering of the twist drill can be simplified and a more even run of the twist drill can be promoted, whereby the surface quality of the borehole can ultimately be improved. The fact that the leading secondary cutting edge and the trailing secondary cutting edge lie axially at the same height in the feed direction of the twist drill in the direction of the drill tip, can be achieved, for example, by means of a correction or rounding of the cutting edge corner in the region of the leading secondary cutting edge. In particular, the cutting edge corner, which forms the transition from the main cutting edge to the leading secondary cutting edge, can be ground, for example, by 10° (burr-free ground section) in the region of the leading secondary cutting edge, so that the length of the leading secondary cutting edge is shortened and the leading secondary cutting edge and the trailing secondary cutting edge axially lie at the same height in the feed direction of the twist drill in the direction of the drill tip.

A radial depth of the secondary chip grooves can be 25% to 30% of the radial depth of the main chip grooves.

The secondary chip groove adjoining the trailing secondary cutting edge discharges material removed by the trailing secondary cutting edge in the direction of the trailing main chip groove, which ends in the secondary chip groove. The secondary cutting edge in particular serves the purpose of post-processing the borehole created by the main cutting edges. Compared to the main cutting edges, which perform the majority of the machining work and the removed chips of which are discharged via the main chip grooves, the trailing secondary cutting edges only serve the purpose of post-processing the bore wall, so that a radial depth of the secondary chip grooves in the range of 25% to 30% of the radial depth of the main chip grooves can provide a suitably large volume for the chip discharge, while a good stability of the webs is ensured at the same time.

In terms of a good and even support of the cutting forces acting on the secondary cutting edges or on the leading and trailing web, respectively, a web width of the trailing web measured transversely to the direction of extension can be 70% to 90% of the web width of the leading web measured transversely to the direction of extension, for each web.

In a further embodiment, each web forms a main cutting edge, which has a smaller tip angle in the region of the drill core than outside the drill core.

The smaller tip angle in the region of the drill core simplifies the centering of the twist drill. In particular, the twist drill can have a centering tip in the region of the drill core. An exact, clean spot drilling without off-center running, in particular when drilling without preliminary bore or on smooth surfaces, is thus made possible.

The course of the main cutting edge can be corrected by means of a point thinning in the region of the drill core.

By means of the point thinning, the main cutting edge can be divided into an inner main cutting edge section, which lies in the region of the point thinning and which extends radially inwards to a cross cutting edge, and an outer main cutting edge section, which lies radially outside the point thinning and which extends radially outwards to a cutting edge corner. The point thinning can shorten the length of the cross cutting edge, whereby the centering of the twist drill is further improved.

The tip angle in the region of the drill core can advantageously lie between 110° and 130°, preferably be 120°.

In a further embodiment, the main cutting edges in a region outside the drill core can have a tip angle of between 170° and 190°, preferably 180°.

In the region outside the drill core to a cutting edge corner, the tip angle does not have to be constant but can suitably vary, depending on the material to be drilled. For example, in a region of the main cutting edge, the cutting edge corner can, in terms of a stabilization, be rounded or ground, respectively, so that a first, which has a tip angle of 160°, results in a radially outer region of the main cutting edge.

The leading webs can each have a guide chamfer.

The guide chamfer in particular adjoins the leading secondary cutting edge of the leading web in the circumferential direction. The guide chamfer of the leading web supports the centering of the twist drill in the borehole and ensures that the twist drill is guided exactly axially during the drilling process, whereby straighter and more precise boreholes can be formed.

The trailing webs can each have a guide chamfer.

In particular, the guide chamfer adjoins the trailing secondary cutting edge of the trailing web in the circumferential direction. The guide chamfer of the trailing web supports the centering of the twist drill in the borehole and ensures that the twist drill is guided exactly axially during the drilling process, whereby straighter and more precise boreholes can be formed.

The twist drill can have at least one cooling lubricant channel for feeding cooling lubricant into the region of a main cutting edge. The at least one cooling lubricant channel advantageously ends in a clearance surface of the cutting wedge of the main cutting edge.

The cutting edges of the main cutting edges can be rounded, depending on the material to be machined.

Further details, features and advantages follow from the following description of an embodiment on the basis of the drawings, in which:

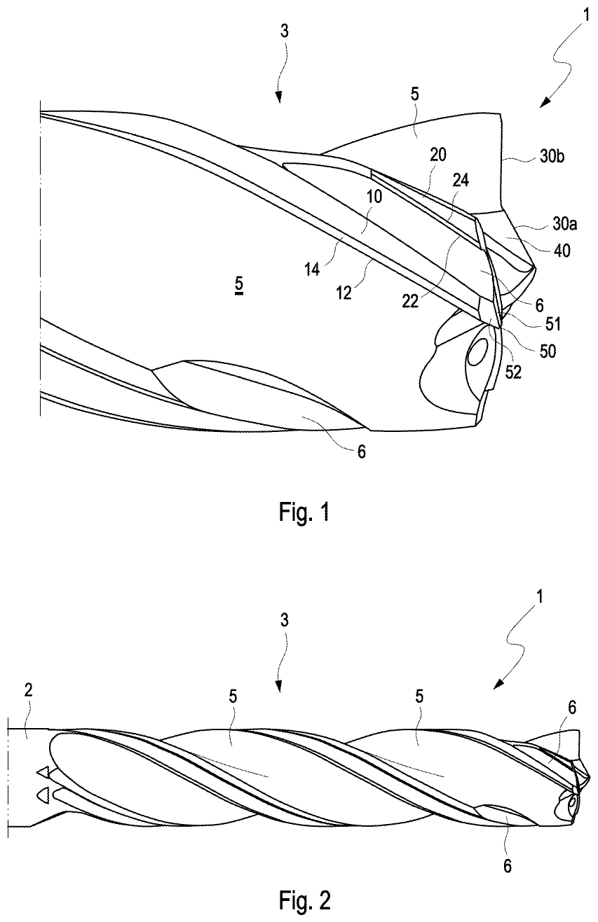

FIG. 1 shows a section of a cutting part of a twist drill according to an embodiment in a side view;

FIG. 2 shows the cutting part according to FIG. 1 in a side view;

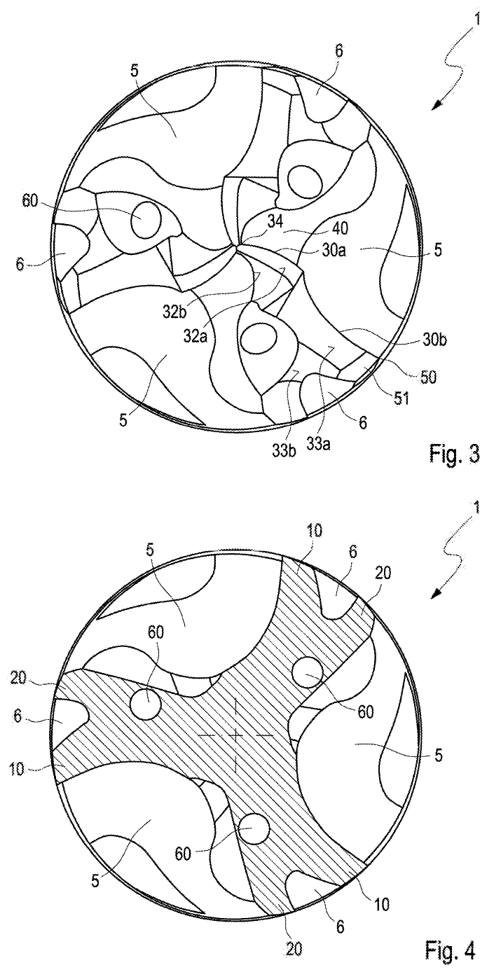

FIG. 3 shows a front view of the twist drill from FIG. 1; and

FIG. 4 shows a view of the twist drill from FIG. 1, which is cut perpendicular to the longitudinal central axis.

### EMBODIMENT

In FIGS. 1 to 4, reference numeral 1 refers to a three-edged twist drill of an embodiment, which rotates clockwise, i.e., the twist drill rotates counter-clockwise in a front view (FIG. 3) and which has a shank 2 suggested in FIG. 2, which extends along a central longitudinal axis, for clamping into a tool chuck as well as a cutting part 3, which is in each case illustrated in a side view in FIGS. 1 and 2.

As shown in FIGS. 3 and 4, the cutting part 3 has three webs, which are separated from one another in the circumferential direction of the twist drill 1 by helically running main chip grooves 5 and which are each divided into a leading web 10 and a trailing web 20, which each have a secondary cutting edge, in the circumferential direction of the twist drill 1 by means of a secondary chip groove 6 running along the web. In particular, the leading web 10 has a leading secondary cutting edge 12 and the trailing web 20 has a trailing secondary cutting edge 22, which lie on the same diameter. A guide chamfer 14 and a clearance surface 14a adjoins the leading secondary cutting edge 12 in the circumferential direction of the twist drill 1 and a guide chamfer 24 and a clearance surface adjoins the trailing secondary cutting edge 22. For each web, the trailing web 20 ends upstream of the leading web 10 in the direction of the shank 2. The secondary chip groove 6 furthermore ends in a trailing main chip groove 5. In a region 7, which lies axially downstream from the trailing web 20, i.e., axially downstream from the outlet of the secondary chip groove 6, the main chip groove 5 thus extends in the circumferential direction of the twist drill 1 to a back 14b of the leading leading web 10, as shown in FIGS. 1 and 2.

By means of this design, it is achieved, compared to a twist drill, in the case of which the trailing web, like the leading web, extends over the entire axial length of the cutting part to the shank, that the trailing secondary cutting edge 22 formed on the trailing web 20 is shorter in the direction of its extension. The formation of relatively long continuous chips or spiral chips, which can impede the drilling process or which can jam with the bore wall, due to the trailing secondary cutting edge 22 can thus be prevented. Chips, which are removed from the bore wall by the trailing secondary cutting edge 22 can be transferred into the trailing main chip groove 5 via the secondary chip group 6 ending in the trailing main chip groove 5 and can finally be transported away securely and reliably in the direction of the shank 2 via the trailing main chip groove 5.

On its front end, which is illustrated on the right in FIG. 1, in the feed direction of the tool, each web forms a main cutting edge, the course of which is corrected by means of a point thinning 40 in the region of the drill core. By means of the point thinning 40, the main cutting edge is divided into an inner main cutting edge section 30a, which lies in the region of the point thinning 40 and which extends radially inwards to a cross cutting edge 34, and an outer main cutting edge section 30b, which lies radially outside the point thinning 40. As furthermore follows from FIG. 1, the twist drill 1 has a centering tip with a tip angle of 120° in the region of the point thinning 40 or the inner main cutting edge section 30a, respectively. In the shown embodiment, the tip angle in the region of the outer main cutting edge section 30b is 180°.

The inner main cutting edge section 30a is defined by a chip surface, which was created by means of the point thinning 40, and an inner first clearance surface 32a, which has a first clearance angle. Against the direction of rotation of the twist drill 1, an inner second clearance surface 32b adjoins the inner first clearance surface 32a, the second clearance angle of which is larger than the first clearance angle of the first clearance surface 32a,

The outer main cutting edge section 30b is defined by a chip surface of the main chip groove 5 and an outer first clearance surface 33a, which has a first clearance angle. Against the direction of rotation of the twist drill 1, an outer second clearance surface 33b adjoins the outer first clearance surface 33a, the second clearance angle of which is larger than the first clearance angle of the first clearance surface 33a. The main cutting edge or the outer main cutting edge section 30b, respectively, runs radially outwards to a cutting edge corner 50, at which the main cutting edge transitions into the leading secondary cutting edge 12 of the leading web 10. As illustrated in the front view of FIG. 3, the outer main cutting edge section 30b runs in a sickle-shaped manner from the point thinning 40 to the cutting edge corner 50.

In the shown embodiment, the cutting edge corner 50 is rounded by means of ground sections and has a first ground section 51 (see FIG. 3) in the region of the main cutting edge and a second ground section 52 (see FIG. 1) in the region of the leading secondary cutting edge 12. By means of the first ground section 51, the tip angle of the main cutting edge is 160° in this region in the shown embodiment. By means of the second ground section 52, which can be referred to as burr-free ground section and which is 10° in the shown embodiment, it is achieved that the leading secondary cutting edge 12 and the trailing secondary cutting edge 22 lie axially at the same height in the feed direction of the twist drill 1 in the direction of the drill tip, as shown in FIG. 1.

Cooling lubricant channels 60 running within the webs, which serve the purpose of feeding cooling lubricant to the main cutting edges, are illustrated in FIGS. 3 and 4. The mouth openings of the cooling lubricant channels 60 in each case lie in a region of the inner second clearance surface 32b and outer second clearance surface 33b.

In the shown embodiment, the leading secondary cutting edges 12 and the trailing secondary cutting edges 22 each have a positive back rake angle and run parallel to one another. The length of the trailing secondary cutting edge 22 for each web furthermore lies in a range of 5% to 10% of the length of the leading secondary cutting edge 12.

### Alternative Embodiments

In the shown embodiment, the leading secondary cutting edge and the trailing secondary cutting edge of each web each have a positive back rake angle. However, depending on the material to be machined, on the demands on the surface quality to be achieved and on the desired stability of the secondary cutting edges, the back rake angle of the secondary cutting edges can also be 0° or negative.

In the shown embodiment, the cutting edge corners are rounded by means of the first point thinning in the region of the leading secondary cutting edge and by means of the second point thinning in the region of the outer main cutting edge section in terms of a stabilization. Depending on the material to be machined, the cutting edge corners can have only the first ground section in the region of the leading secondary cutting edge, only the second ground section in the region of the outer main cutting edge section or no ground section at all.

### LIST OF REFERENCE NUMERALS

1 twist drill
2 shank
3 cutting part
5 main chip groove
6 secondary chip groove
7 region
10 leading web
12 leading secondary cutting edge
14 guide chamfer
14a clearance surface
14b back
20 trailing web
22 trailing secondary cutting edge
24 guide chamfer
30a inner main cutting edge section
30b outer main cutting edge section
32a inner first clearance surface
32b inner second clearance surface
33a outer first clearance surface
33b outer second clearance surface
40 point thinning
50 cutting edge corner
51 first ground section
52 second ground section
60 cooling lubricant channel

1. A twist drill with a shank and a cutting part, which has at least two webs, which are separated from one another in the circumferential direction of the twist drill by means of main chip grooves and which are in each case divided into a leading web and a trailing web, which each have a secondary cutting edge, in the circumferential direction of the twist drill by means of a secondary chip groove, which runs along the web, characterized in that for each web, the trailing web ends upstream of the leading web in the direction of the shank and the secondary chip groove ends in a trailing main chip groove.

2. The twist drill according to claim 1, wherein the secondary cutting edges each have a positive back rake angle, preferably a positive back rake angle of at least 15°.

3. The twist drill according to claim 1, wherein the length of the trailing secondary cutting edge for each web is 5% to 10% of the length of the leading secondary cutting edge.

4. The twist drill according to claim 1, wherein the leading secondary cutting edge and the trailing secondary cutting edge for each web run parallel to one another.

5. The twist drill according to claim 1, wherein the leading secondary cutting edge and the trailing secondary cutting edge for each web lie at the same diameter.

6. The twist drill according to claim 1, wherein the leading secondary cutting edge and the trailing secondary cutting edge for each web lie axially at the same height in the feed direction of the twist drill in the direction of the drill tip.

7. The twist drill according to claim 1, wherein a radial depth of the secondary chip grooves is 25% to 30% of the radial depth of the main chip grooves.

8. The twist drill according to claim 1, wherein each web forms a main cutting edge, which has a smaller tip angle in the region of the drill core than outside the drill core.

9. The twist drill according to claim 8, wherein the course of the main cutting edge is corrected by means of a point thinning in the region of the drill core.

10. The twist drill according to claim 8, wherein the tip angle in the region of the drill core lies between 110° and 130°.

11. The twist drill according to claim 8, wherein the main cutting edges in a region outside the drill core have a tip angle of between 170° and 190°.

12. The twist drill according to claim 1, wherein the leading webs each have a guide chamfer.

13. The twist drill according to claim 1, wherein the trailing webs each have a guide chamfer.

14. The twist drill according to claim 8, wherein the tip angle in the region of the drill core is about 120°.

15. The twist drill according to claim 8, wherein the main cutting edges in a region outside the drill core have a tip angle of about 180°.
